(19) United States
(12) Patent Application Publication
(10) Pub. No.: US 2006/0255218 A1
(43) Pub. Date: Nov. 16, 2006

(54) Suction fixture

(76) Inventor: Chen Kuo Hsiung, (US)

Correspondence Address: JACK SHORE;MUCH SHELIST FREED DENENBERG AMENT&RUBENSTEIN,PC, 191 N. WACKER DRIVE, SUITE 1800, CHICAGO, IL, 60606-1615, US

(21) Appl. No.: 11/216,552

(22) Filed: Aug. 31, 2005

(30) Foreign Application Priority Data
May 12, 2005 (CN) 200520058216.X

(51) Int. Cl. F16M 13/00; F16B 47/00

(52) U.S. Cl. 248/160; 248/205.5

(57) ABSTRACT

The invention is directed to a fixture assembly for connecting a portable electronic product to a stationary object. The fixture depends on suction for adhering the product in place. The fixture includes a flexible supporting rod connecting the electronic product to a suction device. The degree of suction is controlled by a toggle switch acting through a connecting rod connected to a suction piece that secures the product in place.

This application is based on a Chinese Application No. 200520058216.X filed May 12, 2005.

### TECHNICAL FIELD

This new utility model is an assembly for affixing a portable DVD to a stationery object, particularly one that employs suction to hold it in place.

### BACKGROUND OF THE INVENTION

Portable visual electronic products are getting ever more diversified, including such devices as a PDA, pocket TV and palmtop audio visual recorder player (like MP4). These devices are light and compact, have become very popular and have found wide applications in various vehicles, such as automobiles, airplanes and ships. Such units make our life more enjoyable either on trips or at work. However, such products presently have to be held in our hands. This is very inconvenient for extended use or when our hands are needed for other purposes. In addition, the products may fall out of our hands and get damaged. It is therefore necessary to design a fixture assembly that can easily fix any portable visual electronic product to a stationery support, especially on a moving vehicle.

### SUMMARY OF THE INVENTION

The purpose of this new fixture is to provide a simple, reliable and easy to use fixture free from the present technical defects. The fixture employs suction to hold the portable visual electronic products in position.

The objective of this new fixture is achieved by the following structure: The suction fixture is composed of a fixing base for holding the portable electronic unit, a supporting rod and a suction component. The suction component is connected to the fixing base via the supporting rod.

The suction component includes a suction body suction piece, connecting rod and toggle switch. The connecting rod passes through the suction body and is connected to the suction piece at one end and to the toggle switch at the other. The toggle switch is also contact connected to the suction body. If the suction body is made of soft materials (like rubber or plastic), a rigid piece (metal) can be set between the toggle switch and the suction body to make the contact surface with the toggle switch more rigid.

The suction body is concave and evenly edged. The elastic suction piece has one side jointed to the suction body and the other smooth side is applied against the object to which it is to be connected.

The connecting rod can be embedded into or adhere to the suction piece, and hinged to the toggle switch. Specifically, at the adjoining ends of both the connecting rod and toggle switch are holes, into which studs are inserted to connect the connecting rod with the toggle switch.

The toggle switch has different configurations along its end to be connected to the suction body. These configurations are located at different distances from the hinging hole of the toggle switch. By adjusting the different configurations of the toggle switch to be contact connected to the suction body, it is possible to change the position of the connecting rod relative to the toggle switch. This adjusts the deformation extent of the suction piece, and thus the suction force.

The connecting rod has a coaxial spring located inside the suction body. The spring is contact connected at one end to the end of the connecting rod (or suction piece) and its other end to the inner side of the suction body. The spring helps restore the suction piece and connecting rod.

The suction component may consist of one or more groups, usually two groups, that are symmetrically set on opposite sides of the supporting rod and can be hinged to each other at different angles to fit with suction surfaces of different radians.

The supporting rod includes a freely bendable internal rod and an external sleeve, with the internal rod socketed into the external sleeve. The internal rod can be made of easily foldable metal that can be bent and fixed as desired.

The fixing base consists of a base body and a movable clamping piece. The base body has a clamping flange, and the movable clamping piece is screwed together with the portable visual electronic product. At the back of the movable clamping piece is a clamping block, through which the movable clamping piece and base body are clamped into the clamping flange.

The base body of the fixing base has an elastic stopper. The stopper is located at one end of the clamping flange and can be locked after the movable clamping piece is clamped into the clamping base so as to prevent the portable visual electronic product from slipping.

The suction fixture adheres firmly to a smooth surface (like a wall or the glass of your car) through the suction component at one end of the fixture. The portable visual electronic product is connected to the fixing base at the other end of the suction fixture. The supporting rod is then adjusted to give your portable visual electronic product a desired visual angle.

This fixture is superior to the existing technologies in that it is safe and can be used to fix your portable visual electronic product stably and reliably to enable you to enjoy programs without holding it with your hands. You no longer have to worry about your visual product falling out of your hands. Therefore, this novel device provides convenience and safety at the same time. This suction fixture can adhere to a flat or arcuate surface. It enables one to flexibly and easily adjust the visual direction and angle of your visual products. It applies to common vehicles like various automobiles. This device is applicable to fixing all existing portable visual electronic products, such as PDA, pocket TV, palmtop audio visual recorder player and portable DVD players in a stable position in a moving vehicle.

To have a better understanding of the invention, reference is made to the following detailed description of the invention, from the claims and from the accompanying drawings in which:

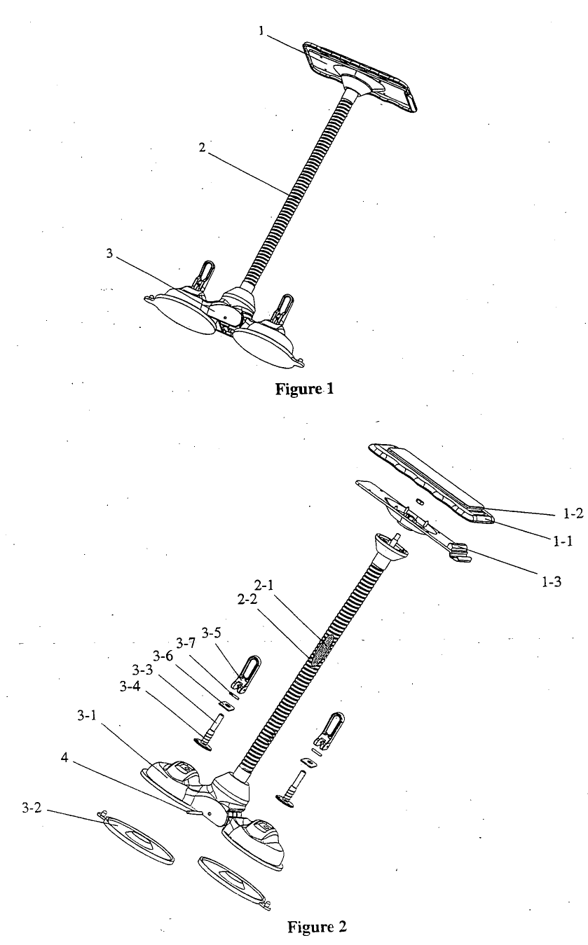

FIG. 1 shows a perspective view of the novel suction fixture;

FIG. 2 shows an exploded perspective view of the suction fixture shown in FIG. 1;

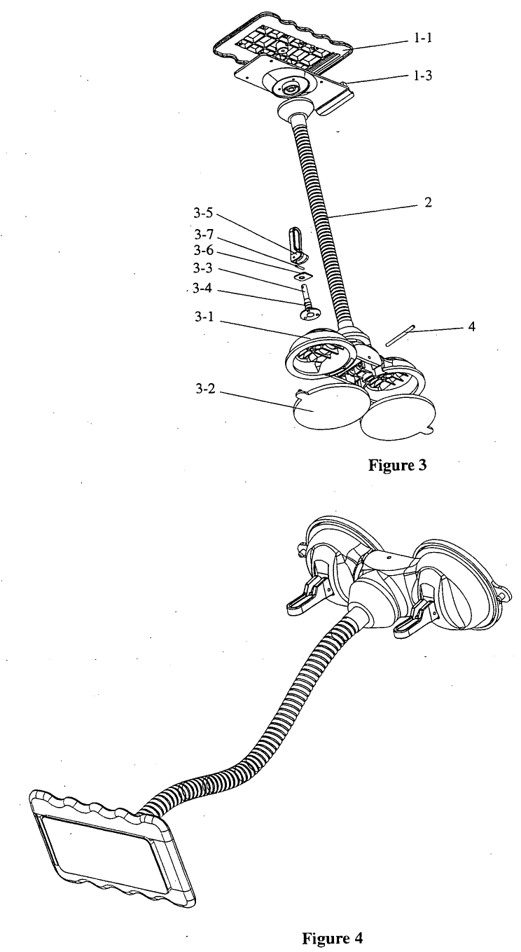

FIG. 3 shows a fixture as shown in FIG. 2 from another angle; and

FIG. 4 shows the suction fixture of FIG. 1 in its use position.

### DETAILED DESCRIPTION OF THE DRAWINGS

This new fixture will be exemplified and illustrated in more detail below, but it has more applications than provided here.

FIG. 1 shows the outline of the suction fixture. It may be seen from FIG. 1 that the suction fixture is composed of fixing base 1, supporting rod 2 and a suction component 3. The suction component 3 is connected to the fixing base 1. The specific structures of respective parts are shown in FIGS. 2 and 3.

From FIGS. 2 and 3 we can see that there are groups of suction components 3, that are symmetrically set on the opposite sides of the supporting rod 2. These groups are hinged to each other via a stud 4 so they can be set at different angles to fit with suction surfaces of different radians. Each suction component group 3 includes a suction body 3-1, suction piece 3-2, connecting rod 3-3, spring 3-4, and toggle switch 3-5. The connecting rod 3-3 passes through the suction body 3-1, and is connected to the suction piece 3-2 at one end and to the toggle switch 3-5 at the other. The toggle switch 3-5 is pivotally connected to the suction body 3-1. The connecting rod 3-3 has a coaxial spring 3-4 that is located inside the suction body 3-1. The spring 3-4 is contact-connected at one end to the end of the connection rod 3-3 (or suction piece 3-2) and at its other end to the inner side of the suction body 3-1. The spring 3-4 thus helps restore the suction piece 3-2 and connecting rod 3-3 when the toggle switch is released.

A rigid piece (metal) 3-6 is set between the toggle switch 3-5 and the suction body 3-1 and is concave and evenly edged. The suction piece 3-2 is elastic, usually made of rubber or plastic, with one side joined to the suction body 3-1 and the other smooth side sucking the target object.

The connecting rod 3-3 is embedded into the suction body 3-1, and hinged to the toggle switch 3-5 at the adjoining ends of both the connecting rod 3-3 and toggle switch 3-5. The toggle switch 3-5 has different configurations at the end to be connected to the suction body 3-1, and those configurations are at different distances from the hinging hole of the toggle switch 3-5. Thus by adjusting the different configurations of the toggle switch to be connected to the suction body 3-1, it is possible to change the position of the connecting rod 3-2 and thus adjust the deformation extent of the suction piece 3-2, to adjust the suction force. The supporting rod 2 includes a freely bendable internal rod 2-1 and an external sleeve 2-2. The internal rod 2-1 can be made of easily foldable metal that can be bent and fixed as desired. The fixing base 1 consists of the base body 1-1 and a movable clamping piece connected to the portable visual electronic product. (not shown in the figures). The base body has a clamping flange 1-2, and the movable clamping piece is screwed together with the portable visual electronic product.

At the back of the movable clamping piece is a clamping block (not shown), through which the movable clamping piece and base body 1-1 are clamped into the clamping flange 1-2. The base body 1-1 of the fixing base 1 has an elastic stopper 1-3, which is located at one end of the clamping flange 1-2 and can be locked after the movable clamping piece is clamped into the base body 1-1 so as to prevent the portable visual electronic product from slipping.

The new suction fixture works as follows:

Fix one end of the suction component 3 of this suction fixture to a smooth surfaced and the elastic suction piece 3-2 can adhere to the target suction surface. Turn down the toggle switch 3-5 to overcome the action of the spring 3-4 and lift the connecting rod 3-3. At the same time, the connecting rod 3-3 lifts the elastic suction piece 3-2 connected to it, forming a vacuum between the middle of the elastic suction piece 3-2 and the target suction surface. In this way, the suction component 3 may adhere firmly to the target surface. The portable visual electronic product is fixed to the fixing base 1, and then one can adjust the supporting rod 2 to give the portable visual electronic product a desired visual angle, as shown in FIG. 4.

It is intended to cover by the appended claims all embodiments and modifications that fall within the true spirit and scope of the invention.

1. A suction fixture assembly for a portable electronic product comprising a fixing base for supporting the electronic product; a flexible supporting rod connected to the fixing base at one end thereof and suction means connected to the other end for securing the portable electronic product to a stationary object.

2. A suction fixture as set forth in claim 1 in which the suction means includes a suction body, a suction piece to be connected to a stationary object, a connecting rod extending through said suction body and connected at one end to the suction piece and at its other end to a toggle switch connected to said suction body for controlling the amount of said suction piece to regulate the suction securing the portable electronic product to a stationary object.

3. A suction fixture as set forth in claim 2 in which the suction piece is elastic in which the inner side is connected to said suction body and the outer side is smooth for affixing the fixture to a portable electronic product.

4. A suction fixture as set forth in claim 2 in which one end of the connecting rod is adhered to said suction piece and its other end is hinged to the toggle switch.

5. A suction fixture as set forth in claim 4 in which the toggle switch defines a varying configuration on its outer surface which is located at different distances from where the toggle switch is hinged to the connecting rod whereby the suction force created by the suction fixture is varied depending on the portion of the outer surface of the toggle switch in contact with the suction body.

6. A suction fixture as set forth in claim 2 in which there is provided a coaxial spring located about said connecting rod with one end of the spring connected to the connecting rod and its other end to the suction body to help restore the suction piece and connecting rod to its normal position when the toggle switch is released.

7. A suction fixture as set forth in claim 2 in which there are separate suction means provided on opposite side of the supporting rod and hinged thereto.

8. A suction fixture as set forth in claim 2 in which the flexible supporting rod consists of a freely bendable internal rod and an external sleeve with the internal rod socketed into the external sleeve.

9. A suction fixture as set forth in claim 1 in which the fixing base consists of a base body and a moveable clamping piece, the said base body has a clamping flange and the said moveable clamping piece is screwed together with the portable visual electronic product, said moveable clamping piece includes a clamping block, at its back through which the moveable clamping piece and base body are clamped into the clamping flange.

10. A suction fixture as set forth in claim 9 in which the base body also includes an elastic stopper located at one end of the clamping flange.
